(19) United States
(12) Patent Application Publication
(10) Pub. No.: US 2019/0110867 A1
(43) Pub. Date: Apr. 18, 2019

(54) DENTAL IMPLANT ANALOG AND METHODS OF MAKING SAME

(71) Applicant: Khachatur Hovhannisyan, Valley Village, CA (US)

(72) Inventor: Khachatur Hovhannisyan, Valley Village, CA (US)

(21) Appl. No.: 15/787,541

(22) Filed: Oct. 18, 2017

(51) Int. Cl. A61C 8/00; A61C 13/34

(52) U.S. Cl. CPC A61C 8/0001; A61C 13/34

(57) ABSTRACT

Embodiments disclosed herein are directed to an improved dental implant analog for use in in the fabrication of dental restorations. The dental implant analog embodiments disclosed herein can have a roughened exterior surface optimized for improved surface bonding with casting materials to increase the strength of dental models used by dental laboratory technicians in the fabrication of dental restorations. Dental models made using conventional dental implant analogs are much more vulnerable to breakage at or adjacent to the location of the dental implant analog. Using the improved dental implant analog disclosed herein increases the strength of the dental model to reduce the risk of breakage of the model, and allows the dental laboratory technician to build more accurate dental models.

### BACKGROUND

### Field

Embodiments of the present disclosure relate to improved implant analog devices used by a dental laboratory in the process of fabricating crowns, bridges, and other dental restorations (collectively referred to herein as “dental restorations”).

### Description of Related Art

An example of a conventional implant analog is shown in FIG. 1. The limitations and drawbacks of conventional analogs will be described below.

### SUMMARY

The systems, methods and devices described herein have innovative aspects, no single one of which is indispensable or solely responsible for their desirable attributes. Without limiting the scope of the claims, some of the advantageous features will now be summarized.

Embodiments of the present disclosure are directed to providing a solution to a significant problem that exists during the fabrication process of dental restorations over the implant, namely, the problem of dental models having insufficient durability to withstand fracture in a portion of the dental model that supports the implant analog as a result of the handling forces and dental laboratory processes in general by dental laboratory technicians during the fabrication process of dental restorations.

The embodiments of the present disclosure are designed to improve the strength and durability of dental models without compromising the accuracy of the dental models, by increasing a bond between the dental model and the implant analog.

In some configurations, an improved analog for use in in the fabrication of dental restorations comprises a roughened exterior surface optimized for improved surface bonding with casting materials.

Some embodiments described herein are directed to an improved implant analog for use in in the fabrication of dental restorations, comprising a main body, and an outside surface of the main body. In any embodiments, to optimize the outside surface of the analog for bonding with a casting material, at least a portion of the outside surface of the main body of the improved implant analog can have a roughness of from approximately 35 micrometers to approximately 550 micrometers. In any embodiments, the analog can be configured, or is, used for fabrication of dental restorations and is not configured for use in a patient's mouth.

In any embodiments disclosed herein, at least a portion of the outside surface can have a roughness of approximately 100 micrometers, or from approximately 50 micrometers to approximately 200 micrometers, or from approximately 100 micrometers to approximately 150 micrometers. The portion of the outside surface of the main body of the improved implant analog that has a roughness of from approximately 35 micrometers to approximately 550 micrometers can be the portion of the outside surface of the main body that will be embedded in the casting material.

Some embodiments described herein are directed to an improved dental model for use in a dental laboratory, comprising a casting material and an improved analog having an exterior surface wherein at least a portion of the exterior surface of the improved analog has been roughened exterior surface adapted to provide better bonding with the casting material. At least a portion of the outside surface can have a roughness of from approximately 35 micrometers to approximately 200 micrometers, or from approximately 50 micrometers to approximately 150 micrometers. The casting material in any embodiments disclosed herein can comprise gypsum, die stone, or other suitable materials.

The improved dental model for use in a dental laboratory can be approximately 15% stronger as compared to a conventional dental model that has the same casting material and a conventional analog that has a non-roughened exterior surface, or from approximately 15% to approximately 20% stronger as compared to a conventional dental model that has the same casting material and a conventional analog that has a non-roughened exterior surface.

Some embodiments described herein are directed to a method of fabricating an improved die used in a dental laboratory for making dental restorations, comprising roughening at least a portion of an exterior surface of an analog, positioning the analog in a desired position in an impression, and advancing casting material around the portion of the analog that has the roughened surface and allowing such casting material to harden. The method can further comprise roughening the exterior surface of the analog using grit blasting such as, but not limited to, sand blasting. In any embodiments, the roughened portion of the exterior surface of the analog can have a roughness of from approximately 35 micrometers to approximately 550 micrometers, or from approximately 50 micrometers to approximately 200 micrometers, or from approximately 100 micrometers to approximately 150 micrometers. In some embodiments, the entire exterior surface of the analog can be roughened. In any embodiments, the casting material can comprise at least one of gypsum, resin, and epoxy.

### BRIEF DESCRIPTION OF THE DRAWINGS

The foregoing and other features of the present disclosure will become more fully apparent from the following description and appended claims, taken in conjunction with the accompanying drawings. These drawings depict only some of the embodiments in accordance with the disclosure and are not to be considered limiting of its scope. The disclosure will be described with additional specificity and detail through the use of the accompanying figure set.

FIG. 1 shows a conventional implant analog.

FIG. 2 shows a dental implant in a patient's mouth.

FIG. 3 shows an impression coping coupled with a dental implant in a patient's mouth.

FIG. 4 shows a dental model of a patient's dentition.

FIG. 5 shows an example of an impression coping and an analog.

FIG. 6 shows an impression coping and an analog being coupled together with a screw.

FIG. 7 shows the impression coping and the analog being positioned back within the opening for the impression coping formed in the impression.

FIG. 8 shows a dental technician installing the metal membranes into the impression, during the soft tissue replica fabricating process.

FIG. 9 shows soft tissue material being injected into the cavity surrounding the analog using a special dispensing gun

FIG. 10 shows the dental technician preparing the dental model for further model preparation.

FIG. 11 shows a bottom up view of the dentition cast with pins installed prior to basing.

FIG. 12 shows the technician inserting the pinned dental model into the base former filled with a special gypsum material.

FIG. 13 shows the model removed from the base formed after special gypsum material is completely set.

FIG. 14 shows a completed articulated dentition assembly.

FIG. 15 shows a single die with removed soft tissue replica in the hand of the technician.

FIG. 16 shows the side view of a non-implant dentition cast.

FIG. 17 shows oclusal marking paper between the dental restoration and the replica of an adjacent tooth.

FIG. 18 shows a graph illustrating inaccuracies from dies.

FIG. 19 shows a dental crown properly seated on a solid (i.e., non-sectioned) dentition cast, which can be used as part of the process for checking interproximal contacts.

FIG. 20 is a section view illustration of the die region of the dental model where the analog is positioned.

FIG. 21 shows a typical analog engaged with an impression coping used by dental laboratory technicians in the process of making dental restorations.

FIG. 22 shows a fractured die that has fractured at the point of the dental model where the analog was positioned.

FIG. 23 shows an embodiment of an analog of the present disclosure that has a roughened surface finish.

FIG. 24A shows examples of smooth and rough surfaces.

FIG. 24B shows a depiction of forces being applied at various angles relative to a roughened surface.

FIG. 25 shows fractured die that has fractured at the point of the dental model where an embodiment of an improved analog of the present disclosure was positioned.

FIG. 26 shows an implant and an analog where “A” in both indicates the area of the fundamental similarities and “B” the fundamental differences between an implant and an analog.

FIG. 27 shows several images of an analog and an implant.

FIG. 28 shows another embodiment of an analog having unique surface roughness characteristics.

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extend beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

The following is a brief overview of some components and methods that may be used by a dental laboratory that makes dental restorations for implantation into a dental patient. Fabricating an accurate and properly fitting dental restoration requires a highly accurate and well-made replica of the patient's dentition (i.e., arrangement of the gums and teeth within a patient's mouth as well as exact position of the implant in relationship with adjacent and opposing teeth). This process starts with taking an impression in the dentist's office, and the accuracy of the dental model (also referred to as a casting) relies greatly on accurately locating the analog in the dental model.

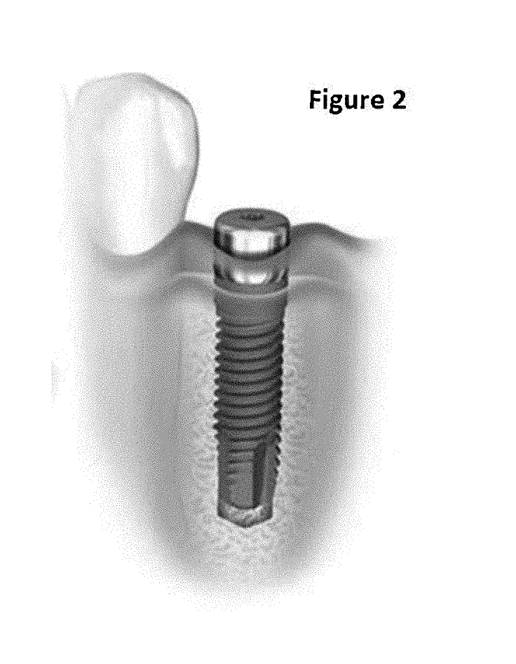

A dental implant (also referred to just as an implant) generally provides the anchor or foundation for a restoration (i.e., a crown or false tooth). An example of a dental implant is shown in FIG. 2. A dental implant is only used in a patient, and is never used in a dental laboratory or by a dental laboratory technician in the fabrication of a dental restoration. A dental implant is typically screwed into the patient's jaw bone, and provides a fixed platform or anchor point to a patient's jaw on which or with which an implant abutment can be engaged. The abutment will typically couple directly with the implant with a screw, and provides the support base or the foundation for a crown or other dental restoration. A crown or other dental restoration will typically be adhered to and be positioned over the abutment. There are also screw retained restorations, which can be screwed/coupled in to the implant directly eliminating need of cement/adhering and implant abutment in general.

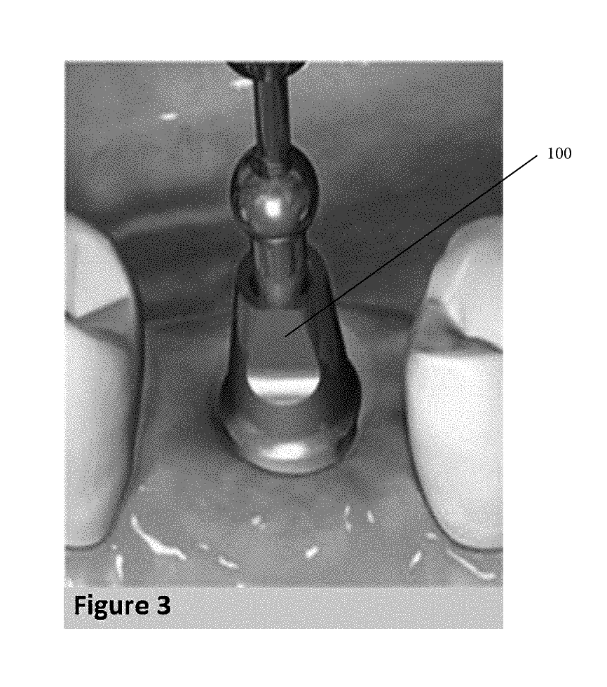

Importantly, in order for the dental laboratory technician to fabricate an accurate and properly fitting dental restoration, the dental laboratory technician must have or be provided with an accurate impression of the patient's mouth, including the position of the dental implant and adjacent teeth. The location of the dental implants, as well as the size, position, and other details of the adjacent teeth, must be accurately represented in the impression. The impression of the patient's mouth is typically formed after the implant has been permanently fixed in the patient's jaw, usually after a period of time after the implant has integrated with the patient's bone structure. The implant usually seats or located few millimeter below the surface of the gum. In order to accurately register the position of the implant in the patient's mouth, an impression coping (a specially designed metal post) is typically coupled with the implant prior to making the impression of the patient's mouth. The impression coping is used during the impression taking procedure to accurately replicate the position of the implant in relation to the adjacent and opposing teeth as well as to record the depth of implant under the gums. The impression coping can be thought of a post that is engaged with the implant in the same way that the abutment or future restoration will be engaged with the implant. An example of an implant coping is shown in FIG. 3.

As such, impression copings are typically used by the dentist to register the position of the dental implant in the patient's mouth. With reference to FIG. 3, the dentist will typically engage the impression coping (which can be referred to as a post) to the dental implant. Then, after coupling the impression coping with the implant using a screw, the dentist will take an impression. The impression, with impression coping, will thereafter be sent to the dental laboratory for use in fabricating the dental restoration. Other techniques can be used also, such as what is known as the open tray technique. In this technique, the impression coping is retained in the impression material permanently. When the impression material is set in the mouth, the dentist will typically unscrew it before removing the impression/tray from the mouth.

An analog (also referred to as implant replica) is typically used by laboratory technicians to replicate the implant that has been permanently implanted in the patient's mouth or jaw. An analog is never actually used in a patient's mouth and is never even introduced, even temporarily, into a patient's mouth. As stated above, a model of the patient's dentition is cast using an impression. The analog is typically coupled with the impression coping using a screw. Once the analog (which, again, replicates the dental implant) is affixed to the impression coping and set together in to the impression, the dental laboratory technician (also referred to herein as the dental technician) can thereafter fabricate a model of the patient's dentition using the impression. Recall that the impression was formed around the patient's teeth and gums, so is essentially a negative impression of the patient's dentition. To make an accurate and properly fitting dental restoration, the dental laboratory technician must create the model of the patient's dentition using the impression.

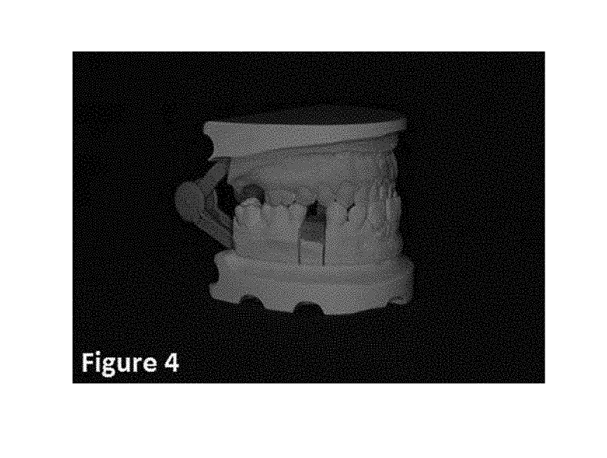

With the analog projecting out of the impression, the dental technician will then pour the impression with suitable material to make a positive cast of the teeth and recorded location of the implant. Any embodiments of the dental model disclosed herein can be made from die stone gypsum, model stone gypsum, resin die stone, die stone, plaster, rock, stone, flowstone, resin rock, or any other suitable casting material. The gypsum materials or products that can be used with any of the embodiments disclosed herein include, but are not limited to, Type I, II, III, IV, and V. Thereafter, the dental technician will have an accurate dental model of the patient's dentition, with the analog positioned in the dental model in the same relative position as compared to the dental implant that is positioned in the patient's mouth. FIG. 4 shows an example of a dental model made using such a cast of a patient's dentition. Using this dental model, which may also be referred to as a dental model, the dental technician can make an accurate and properly fitting dental restoration. Therefore, well prepared implant models provide a very accurate fixed reference platform for the dental laboratory technician, providing an accurate replica of the position of the implant in the patient's dentition in relation to opposing and adjacent teeth, from which the laboratory technician can fabricate a dental restoration.

Additionally, because the dental model is handled physically and sometimes aggressively by the dental laboratory technician during the fabrication process for the dental restoration, and because the thickness of dental models (also referred to as a dentition cast) must be minimized in order to maintain the accuracy of the dental model, the durability of the overall dental model is very important. If the dental model is not sufficiently durable, the dental model can easily break during the fabrication process, causing the dental laboratory technician to have to remake the broken dental model. Having to remake a broken dental model is time-consuming, inefficient, and costly. Also, the first time poured cast is the most accurate. After removing the cast from the impression the first time, the impression sustain some physical damage, reducing the accuracy of subsequent castings. So, it is important to preserve the first formed dental model throughout the entire restoration fabrication process undamaged, since subsequent castings will not be as accurate as the first casting. The fabrication of dental restorations is a highly competitive market where any improvements in the durability of the dental models can have a significant benefit to the dental laboratories revenue and schedule. Dentists typically expect the dental restoration to be fabricated and delivered at a set due date established before the impression was sent by the dentist to the dental laboratory, such due date being set in accordance with the schedules of a doctor, the minimum time frame lab required in fabrication of given restoration and convenience of the given patient. So, setbacks suffered by insufficiently durable dental models can have a significant drawback to the dental laboratory business, the doctor's schedule, the patient's schedule, etc. More details about this will be provided below.

Typically, to achieve the necessary accuracy and fit for the dental restoration, the upper portion (i.e., the removable portion, the portion of the dentition cast that later sits on top of model base which in combination becomes a dental model, which is hereinafter referred to as the dentition portion) of the dental models are typically only approximately 10 mm-12 mm thick. Any thickness greater than that can result in a less accurate and potentially improperly fitting dental restoration. Therefore, it is beneficial for the laboratory technician to make a dentition portion of the dental model that has a thickness of approximately 10-12 mm. However, when restoring restoration over the implant at this thickness, the dental model can be much more fragile and much less able to withstand the physical handling necessary during the fabrication process for the dental restoration. Because of this problem, dental technicians often make thick dental casts. Thick dental casts increase the strength of the cast but also increase the inaccuracy of interproximal contacts, the details of which will be provided later. Embodiments of the present disclosure solve and alleviate these problems.

The problem to be solved by embodiments of the present disclosure is how to increase the strength and durability of the dental model in the cases including implant restorations used in the dental laboratory for the fabrication of dental restorations, without increasing the thickness or cross-sectional area of the dentition portion of the dental model to a level which can impair the ability of the dental laboratory technician to create an accurate and properly fitting dental restoration. Dental laboratories tend to make very tall/thick dental models when fabricating models having implant analogs in them to minimize the chance of the dental model being cracked.

Embodiments of the present disclosure are directed to increasing the strength of dental laboratory dental models in the portion of the dental model that supports the implant analog so that the dental model are more robust and durable, thereby reducing the risk that the dental model will fracture during the fabrication process of dental restorations. In any embodiments herein, a height of the die can be decreased using the improved analog embodiments disclosed herein. This can reduce a risk of breakage of the die, and increase the accuracy of the restoration in the areas of interproximal contacts.

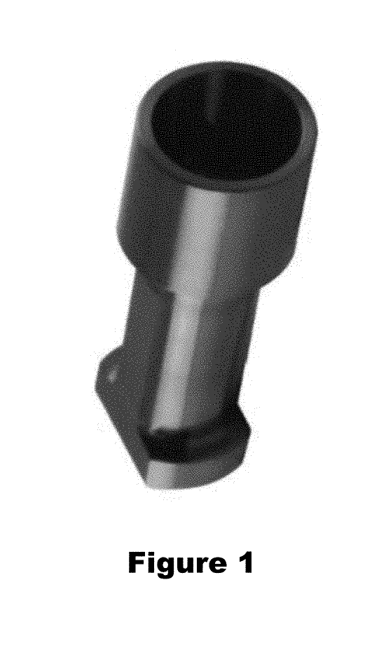

Some embodiments relate to implant analogs for use at dental laboratories for fabrication of crowns, bridges, and other dental restorations (collectively referred to hereinafter as “dental restorations”), such implant analogs having improved surface properties. FIG. 1 shows an example of a conventional implant analog. An implant analog is a manufactured device and can be made from titanium, stainless steel, and/or any other suitable materials. In some embodiments, the implant analog can be made from aluminum. As described above, the analog is typically embedded in the operative dental model and is used to duplicate the position of the dental implant. Analogs are used only during fabrication process for dental restorations. The dental model and the analog are integral to the process of preparing an accurate and properly fitting dental restoration.

As described above, the point or portion of greatest weakness of the dental model is typically the portion of the dental model that has the implant analogue positioned therein. Therefore, there is an increased likelihood that the dental model will break in the portion of the dental model that supports the analog.

Implant analogs are typically made in various metals or alloys. Implant analogs can be made from titanium, aluminum (which can be anodized), stainless steel, and/or any other suitable materials. Conventional implant analogs, such as the analog shown in FIG. 1, typically have a very glossy or very smooth finish, with no significant surface roughness.

It is important to understand that an analog is not a dental prosthetic device and has a very different design and application as compared to a dental implant. Analogues are never placed in a patient's mouth. Analogues are only used as a manufacturing aid during the manufacture of a dental restoration. To the contrary, dental implants are designed for permanent placement in a patient's mouth, in particular, in a patient's jawbone. As such, dental implants are designed and optimized for a completely different purpose and to solve a completely different problem as compared to analogs. In short and without limitation, dental implants are designed and optimized for permanent placement and fixturing within a patient's jawbone and mouth. Dental implants have threads on an external surface thereof to enable the implant to be screwed into the patient's jaw by rotating the dental implant. Analogs of the embodiments of the present disclosure, to the contrary, do not have threading on an exterior surface thereof and are designed to prevent rotation of the analog in the dental model.

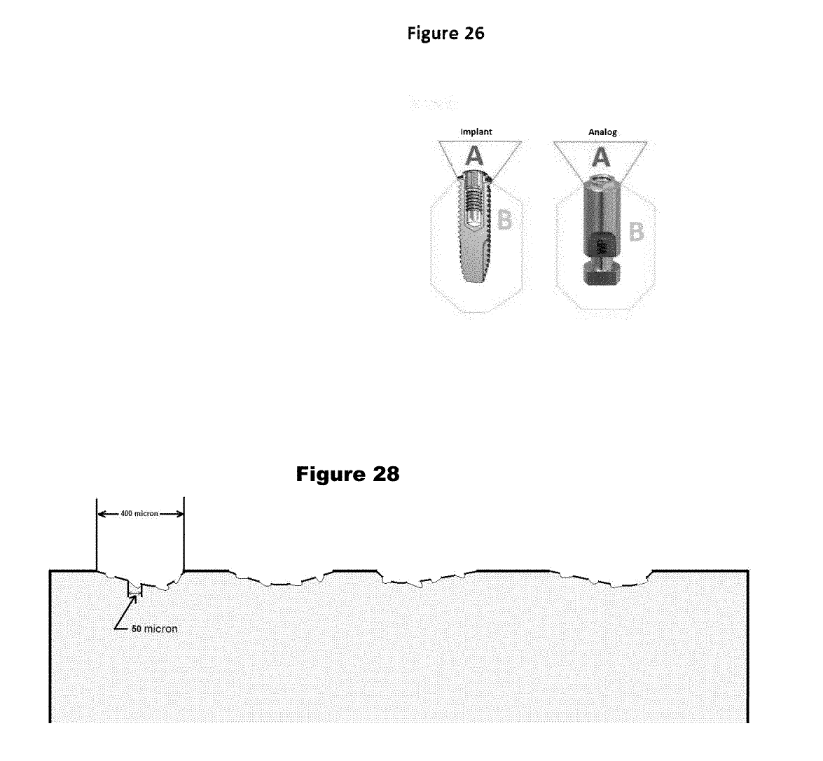

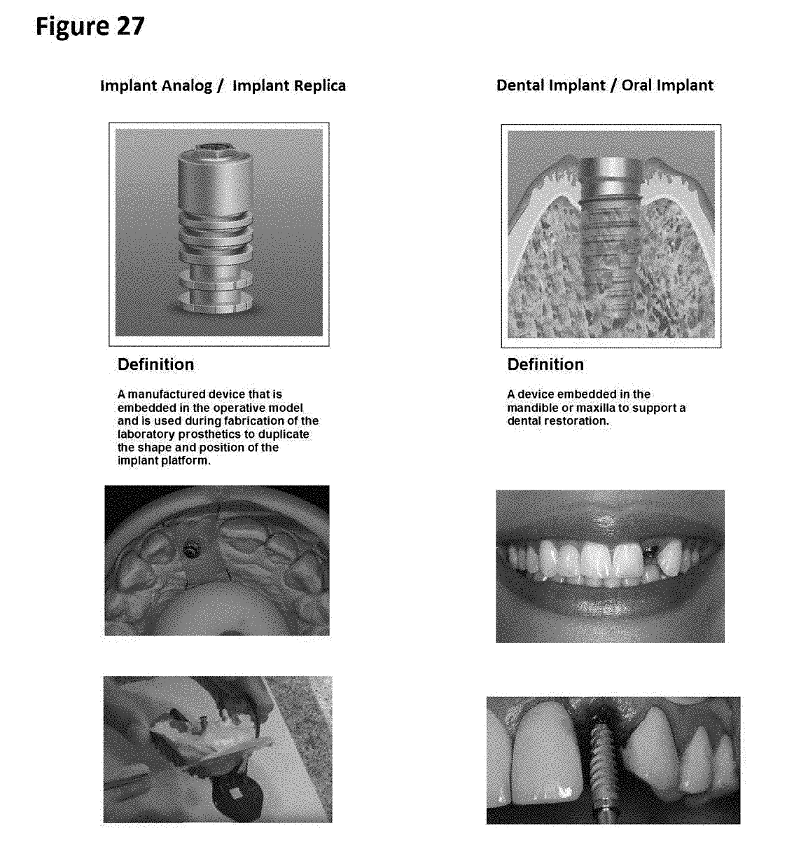

An analogue, in contrast to a dental implant, is designed and manufactured for use in a dental model, which dental model is used in the dental laboratory for making an accurate and properly fitting dental restoration. An analogue, therefore, serves a very distinct and different purpose as compared to a dental implant. Therefore, the exterior design, shape, and features of an implant are very different than the exterior design, shape, and features of an analog. See FIG. 26.

Furthermore, dental implants are never used in the dental laboratory environment and never typically used by dental laboratory technicians. Dental implants are commonly only ever used by dentists in clinical use, who implants the dental implant into the patient's jawbone to serve as a base or foundation for the abutment and/or dental restoration. Therefore, dental laboratory technicians are typically less familiar with the design, features, surface finish, or other characteristics of dental implants.

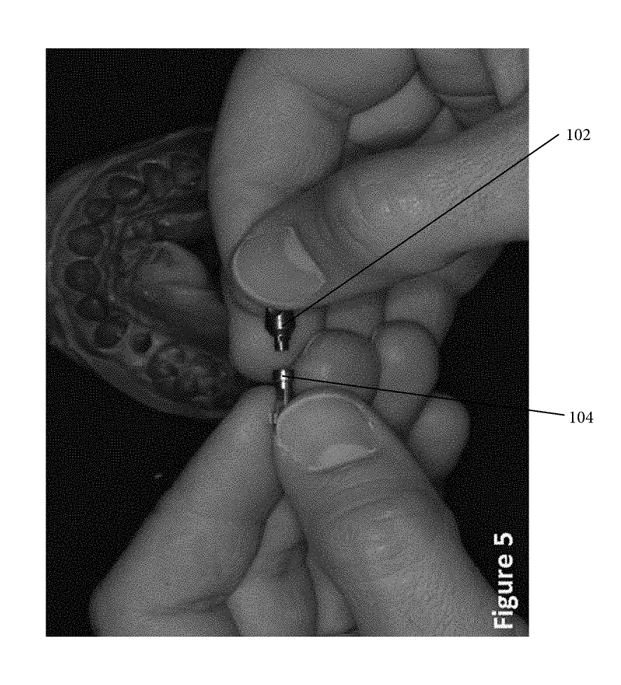

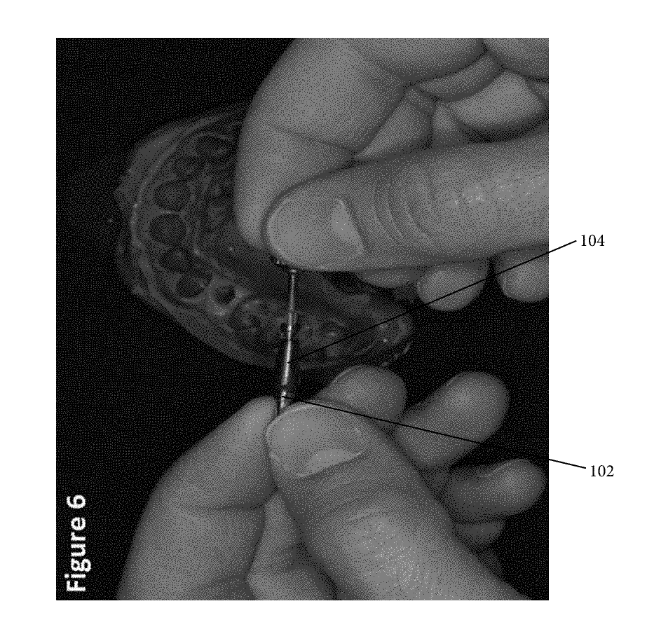

The following is a more detailed explanation of at least some of the steps a dental laboratory technician can follow to fabricate an implant model, after receiving the impression from the dentist. The following description is meant to be exemplifying only and nonlimiting of the steps that can be taken to fabricate in implant model. The first step is to engage the analog 102 with the impression coping 104, as shown in FIG. 5. The analog 102 can then be tightened to the impression coping 104 using a screw that is typically supplied with the impression coping 104, as shown in FIG. 6.

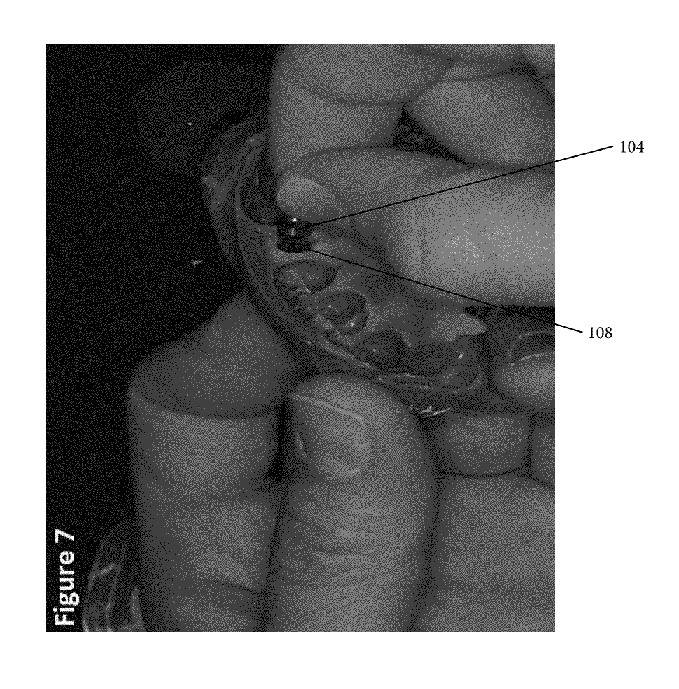

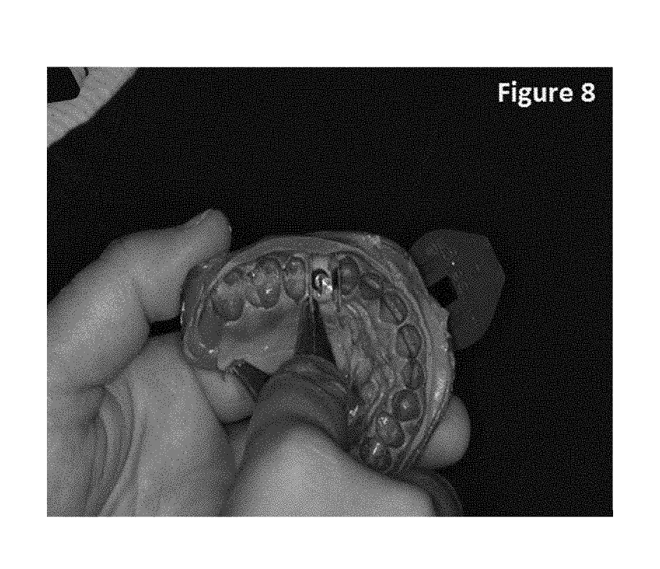

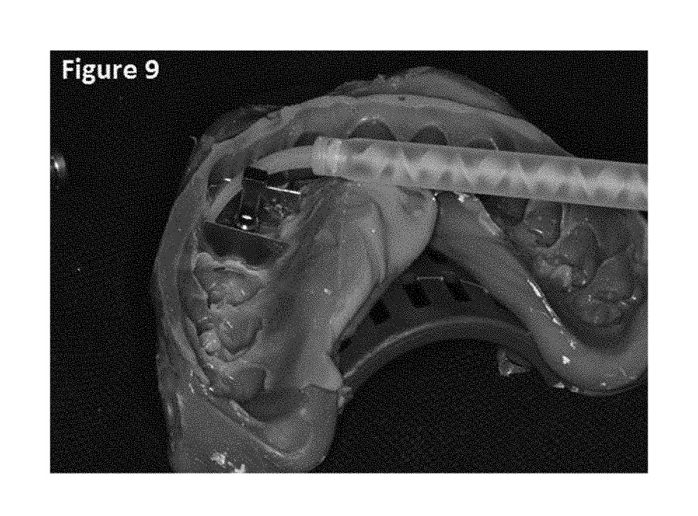

With reference to FIG. 7, once the analog 102 is tightened to the impression coping 104, the assembly (102 and 104) can be inserted back into the recess or opening 108 formed in the impression in the exact same position that the impression coping was in when the impression was formed. The next step is typically to install metal membranes into the impression to prevent the flow of soft tissue material into contact with adjacent teeth. FIG. 8 shows a dental technician installing the metal membranes into the impression. Thereafter, a layer separator is applied and then the soft tissue material is injected into the cavity using a special dispensing gun, as shown in FIG. 9.

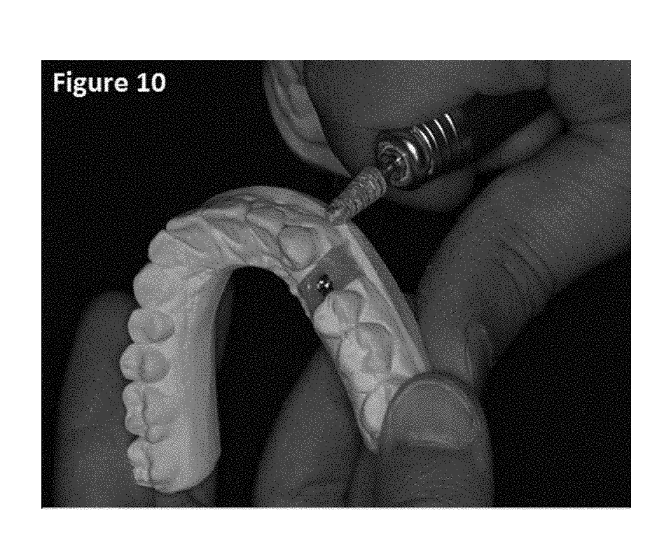

Thereafter, the dental technician can cast the dentition by pouring a suitable compound into the impression, which can be (but are not limited to) a die stone gypsum. After the dental model material has set, the dental technician can remove the dental model from the impression and trim, refine, and/or otherwise prepare the dental model for further model preparation, as shown in FIG. 10.

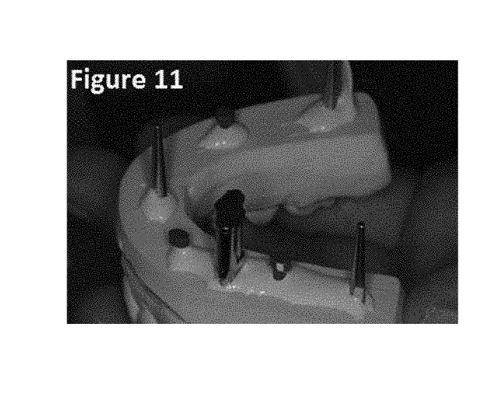

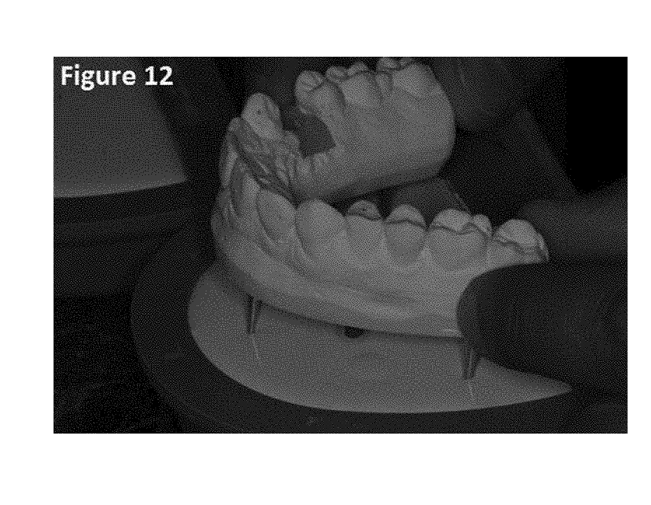

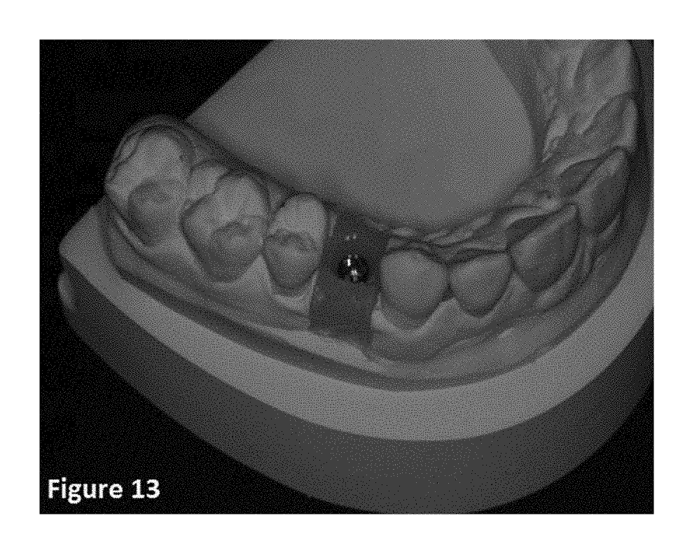

FIG. 11 shows a bottom or bottom-up view of the dental model/dentition cast with pins installed in the dental model. To install pins in the dental model, first, the dental technician drills holes in the dental model in the opposite side of the dentition replica, then places pins and holes. The dental model is now ready to be based in special stone designed to be used for bases. FIG. 12 shows the technician inserting the pinned dental model into the base former filled with a special gypsum material having a more flowable texture. FIG. 13 shows the model removed from the base after the base as completely set.

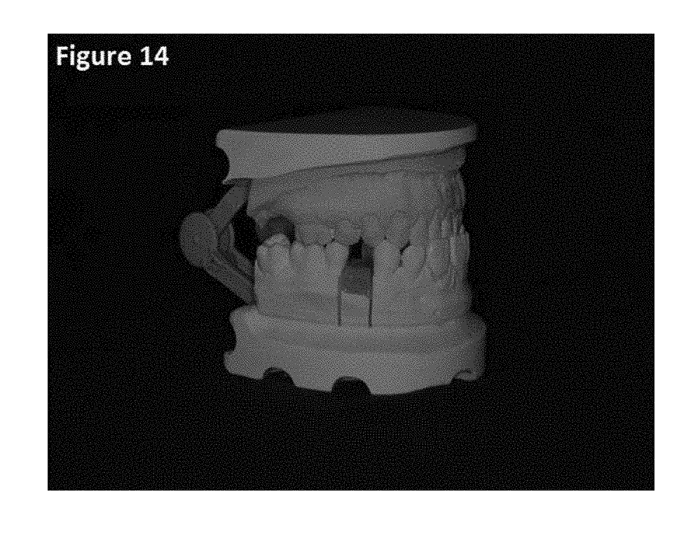

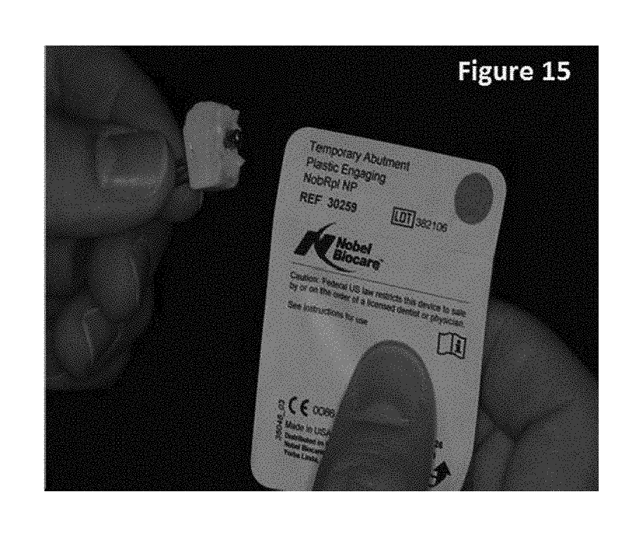

Thereafter, the opposing model is made and the lower and upper models articulated using a special device (referred to as an articulator) that replicates human jaw movement. This is necessary to ensure the proper alignment and fit of the dental restoration in relationship to opposing teeth. FIG. 14 shows the completed articulating dentition assembly, showing the sectioning that is created in the dental model so that the tooth to be restored is a removable die. As a general, but nonlimiting, rule, the replica of the prepared tooth to be restored should be positioned on a removable die which is positioned relative to the rest of the model of the dentition using pins. In this arrangement, the dental restoration to be made can be removed from the model so that the dental technician can easily work on the dental restoration, but also so that the dental restoration can be easily reinserted in the accurate position back in the model to check for a fit with adjacent and opposing teeth, etc. all of this can be done without requiring the dental technician to touch the actual dental restoration with his or her hands. Removal of the die also permits the technician greater access to work on interproximal portions of the restoration, which is more difficult to do when the tooth to be restored is fixed in the designated position within the dental model. FIG. 15 shows a single die with removed soft tissue replica in the hand of the technician.

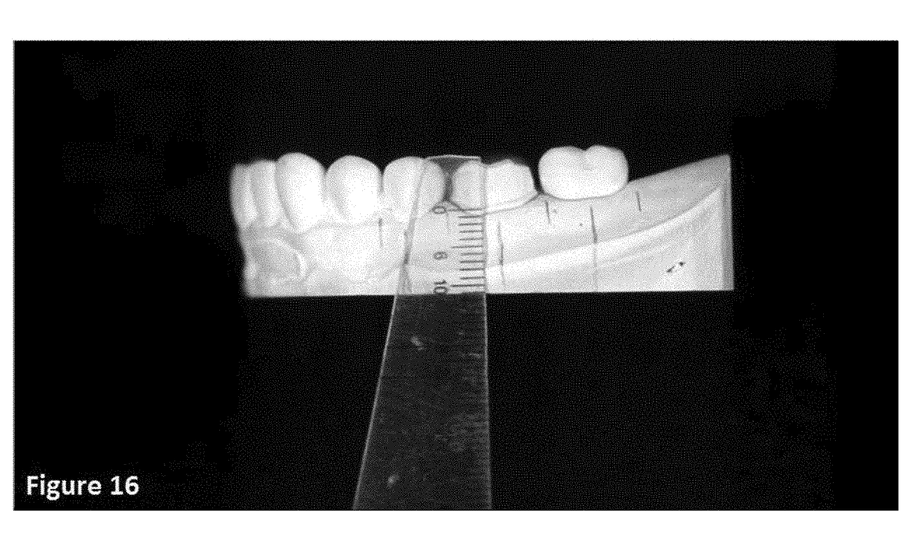

In general, when trimming the dental model during the process of model fabrication, an average thickness of the dentition portion of a dental model of 10 to 12 mm should be maintained between the gingival margin of the tooth to the bottom of the dental model, as shown in FIG. 16. This optimal thickness is recommended and typically followed by dental laboratory technicians to reduce the risk of complications from interproximal contact inaccuracies that can occur if the dental model thickness is greater than 10 to 12 mm.

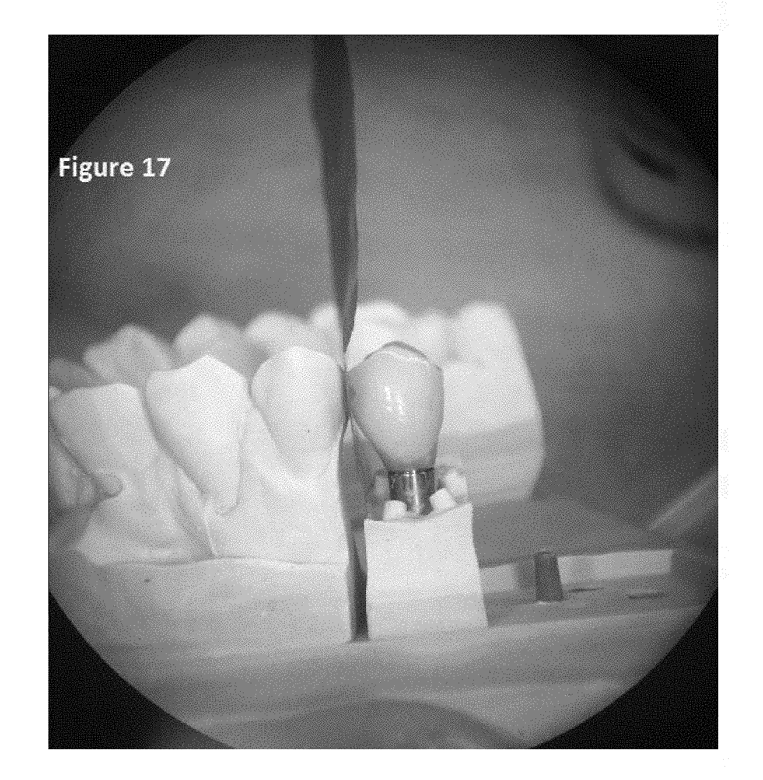

When the dental technician is finalizing the interproximal contacts of the restoration, the dental technician will then use specialized ultra-thin film which is configured to mark pressure points on the restoration. FIG. 17 shows the specialized marking paper between the dental restoration and the replica of an adjacent tooth. The dental technician uses the markings to indicate which portions of the porcelain of the restoration must be added or reduced typically using specialized rotary instruments. This process is repeated until the dental technician feels or detects little to no pressure and does not see heavy pressure marks from the specialized marking paper when pulling inserted film from between the dental restoration and the replica of the adjacent tooth. There should have some retention while pulling out the film from between the teeth but not so much that the film will leave marks on the restoration.

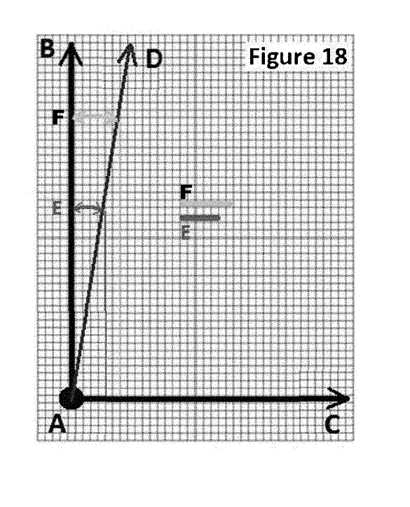

Sectioned models made with even the most accurate pins and sleeves (male and female) can have a lateral moving or movement tendency in general. Additionally, shorter dies typically have greater accuracy as compared to long dies. With reference to FIG. 18, at the same angle of deviation (represented by D), the displacement at F is greater than at E. Similarly, even on the most accurate model, when the model is sectioned, longer dies can experience greater displacements than shorter dies. Adjusting interproximal contacts on a model with such a high dentition cast with loose dies caused by the extra length of it can result in inaccuracy as the loose dies can have less pressure on a marking paper and appear to be adjusted properly. However, in reality, this may be a result of the inaccuracy.

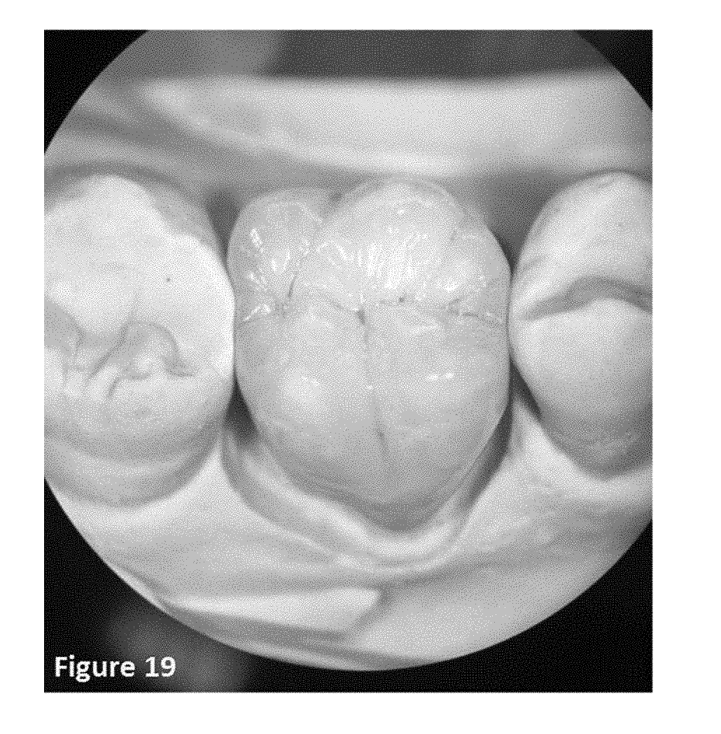

It is recommended that a minimum thickness of 10-12 mm is maintained for dental models to minimize lateral movements yet to provide enough height for a dental technician to handle it throughout the lab work procedure required to fabricate dental restoration. When restoring non-implant case, in addition to the fact that models should be made with suggested height of the dentition cast, these inaccuracies could be also checked and corrected on the “Solid Model”—which is an un-sectioned dental model. FIG. 19 shows a dental crown properly seated on a solid (i.e., non-sectioned) model, which can be used as part of the process for checking interproximal contacts.

However, solid models are not typically used in implant cases due to the cost of making a solid model. Making a solid model as part of this process will bring the cost of the service much higher because of the additional labor time that is involved or required for making a solid model, as well as the additional cost of requiring an additional implant analog for the solid model at this time. Analogs are costly, so must be used efficiently. Therefore, technicians should only rely on an accurately made sectioned working model for ensuring acceptable interproximal contacts.

To maintain the same optimal measurements for the height of the dental model (i.e., to maintain the height between 10-12 mm, the dental model of the implant cases are usually trimmed until bottom surface of the analog is exposed. Exposing the bottom surface of the analog can also give the technician a reference of the location of the analog under the dental model. The pin setting machine cannot drill into the analog. The holes for the pins are typically only be drilled adjacent to the analog.

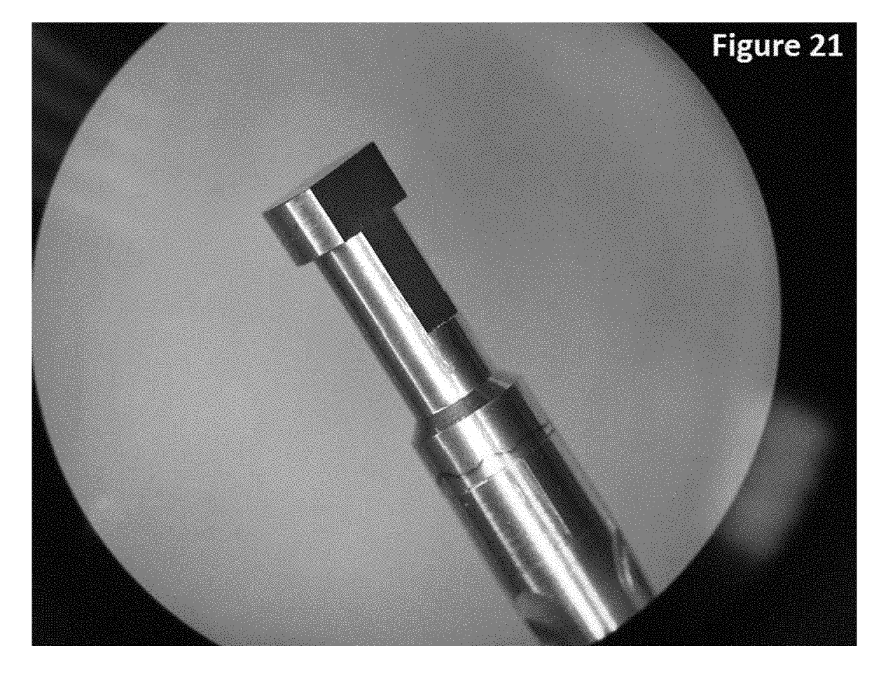

Typical dental model materials which include but are not limited to die stone materials typically have very weak to no bonding capabilities to the analog. This is particularly true because of the fact that analogs typically have a very smooth, low surface roughness finish. In many cases, the analogs are even anodized. FIG. 21 shows a typical analog used by dental laboratory technicians in the process of making dental restorations.

After the impression is poured with casting material, the casting material will typically experience some level of shrinkage during the curing or drying process. During the setting process (curing), the gypsum can shrink and/or expand. Going through both processes during that setting time can cause both materials to detach from one another. During the processes, the implant replica can stay the same during entire setting time/process. The shrinkage that occurs during the curing process can cause the casting material to shrink and move away from an outside surface of a conventional analog having a smooth or low surface roughness finish. Even though the analog is secured in its designated position, what will typically occur is that the casting material will retract away from the surface of a conventional analog, although this may only be visible at a microscopic level.

The height limitation of 10-12 mm of the dental model, the drilling and pinning in the dental model, the gap and/or debonding issue that occurs between the casting material and the analog during the curing process, the low strength of the commonly used casting materials, as well as other factors, all contribute to a weaker dental model in the region of the analog. This can increase the chance of the dental model being broken in the same region of the analog during various restoration fabrication processes performed by the dental laboratory technician. While fabricating various dental appliances, dental technicians impart various forces starting from regular hand pressures applied under various angles up to micro hammering impacts to the dental model, which can result in a high incidence of fracture of the dental model.

Currently, when fabricating a dental model with an implant analog in it, to avoid breaking the dental model, the dental technicians make at least a portion of the dentition cast that exceeds the 10-12 mm height recommendation. In many cases, technicians double the recommended height, resulting in unstable dies having greater sideways movement and greater inaccuracy of the interproximal contacts. This leads to a higher likelihood of an improper fitting dental restoration. Additionally, inexistence of solid model with implant cases further adds to the inaccuracies of the restoration. Inaccurately made restorations create multiple problems clinically. One example of a complication or drawback with inaccurately made dental restorations is improper interproximal contacts—being either too tight or too loose.

To make up for the improper interproximal contacts, the clinicians typically make adjustments on the restoration using marking paper, and/or other steps that, in many cases, should have been done by the dental technician in the lab. This causes additional inconvenience for the patient and time consuming for the dental clinician, resulting in loss of chair time and, hence, revenue. In many cases, the improperly fitting restoration should be sent back to the lab for adding, re-glazing, and/or polishing procedures due to the reshaping operations performed on the dental restoration. If the dental restoration is sent back to the dental laboratory for further processing, this can also result in any or all of the following consequences: patient's time loss as additional office visit will be required for delivering the corrected restoration, loss of chair-time and office staff overhead, increase in labor time of dental technician, increase in cost for shipping or delivery restoration to the lab and back to the office, and loss in patient satisfaction.

Testing of dental models was undertaken to determine the factors contributing to weakened dental models. For research and testing purposes, excessive force was applied on the die with implant analog set inside in a way to replicate similar forces that are imparted on the dental models during fabrication of a restoration. Such forces were applied until the dental model fractured. The fracturing of the dental models during the testing were similar to the fractures experienced in normal handling and processing of dental models during fabrication of the dental restorations. In testing, the same types of materials that are typically used in a dental laboratory were used, including dental die stone-Type IV gypsum, which is generally the most commonly used dental model material used in fabrication of dentition portion of dental model. Importantly, observation of the fractured dental model shows the signs of internal detachment of the dental model material from the surface of the implant analog.

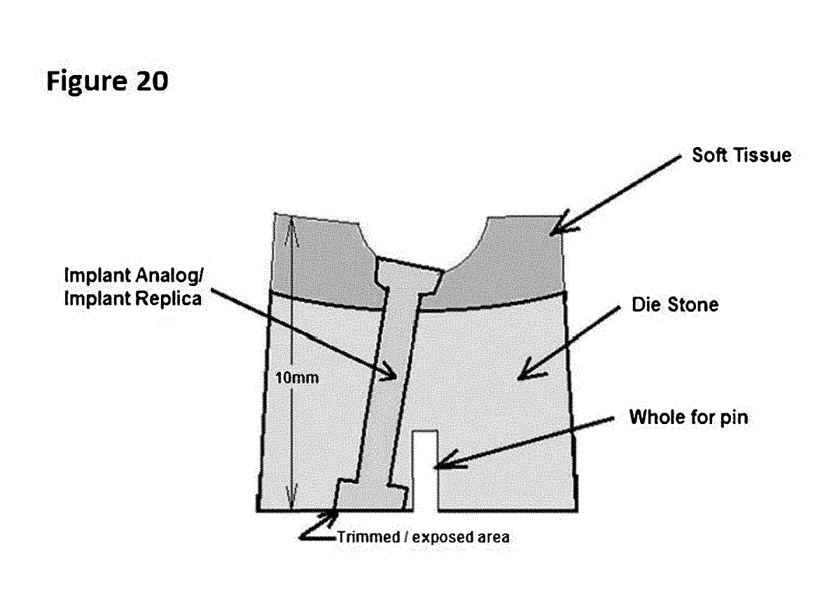

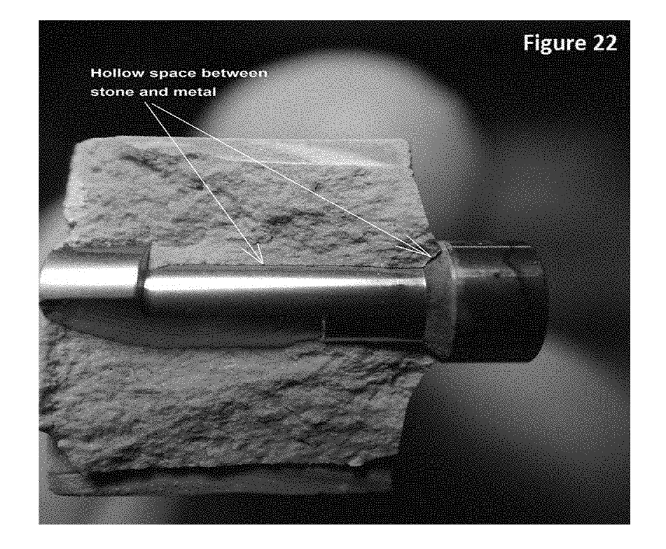

Even though implant analogs have retentive designs mainly designed to prevent rotation, hollow spaces (tiny air gaps or buffer zones) are typically formed between the casting material and the surface of the analog along all or a large portion of the length of the analog. FIG. 22 is a photograph of a fractured die that has fractured at the point of the dental model where the analog was positioned. FIG. 22 also shows a conventional analog having a very smooth, low surface roughness surface. Based on the inventor's observations, even the most accurate gypsum based casting materials typically experience shrinkage and expansion processes during the casting materials sets or dries. When this occurs, as it frequently or invariably does with conventional analogs, the area of glossy surface of the analog and gypsum attached to it becomes the weakest point and shrinkage/expansion of the gypsum makes internal detachment/debond unavoidable. In addition to already existing weakening points in the dental model, there will typically be another hole drilled under the base for mounting metal pin necessary for making removable dies. See FIG. 20 for reference. This results in further weakening this region of the dental model.

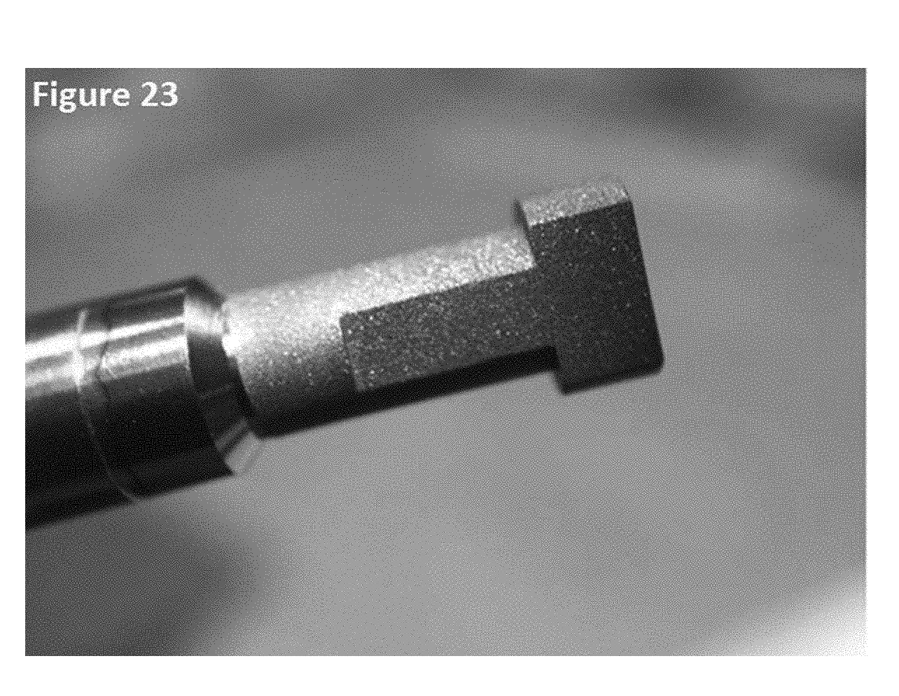

Research performed by the inventor has shown that particular surface treatments of the analog will reduce the likelihood of cracking or fracture of the dental model or die in the portion of the dental model that supports the analog. For example and without limitation, elimination of the glossy surface of the analog can have these improvements. FIG. 23 shows an embodiment of an analog of the present disclosure that has a roughened surface finish. Any embodiments disclosed herein can have a surface roughness from approximately 35 micrometers to approximately 550 micrometers, or, in some embodiments, from approximately 50 micrometers to approximately 200 micrometers, or, in some embodiments, from approximately 100 micrometers to approximately 150 micrometers.

Additionally, in some embodiments, a combination of two or more sizes of pits or depressions, such as in the embodiment shown in FIG. 28. Note that FIG. 28 shows nonlimiting examples of sizes of pits or depressions. The pits or depressions can have any of the sizes or any combination of sizes disclosed in this application. Roughening the surface of the analog can significantly improve the bond between the surface of the analog and the casting material, which can significantly improve the strength and resistance to fracture of the die in the region of the analog as compared to an analog with a smooth and/or glossy surface finish. For example, in any embodiments, the surface can be initially roughened using blasting media that can create 400 micrometer (also referred to as micron) depressions or pits, followed by blasting with smaller media to create smaller depressions such as 50 micrometer depressions or pits, as shown in FIG. 28. In any embodiments, though not required, the first or larger blasting media can have a size of approximately 400 micrometers, and the second or smaller blasting media can have a size of approximately 50 micrometers. In any embodiments, the larger depressions and the smaller depressions can have any suitable size, including any of the sizes within the ranges listed above.

Additionally, in any embodiments disclosed herein, multiple processing steps can be used to create pits or depressions of varying sizes, spacing, or other details. For example and without limitation, in any embodiments disclosed here, 500 micrometer material can be used for grit blasting, following by chemical etching that can be used to create smaller depressions, for example, 100 micrometer depressions after the grit blasting.

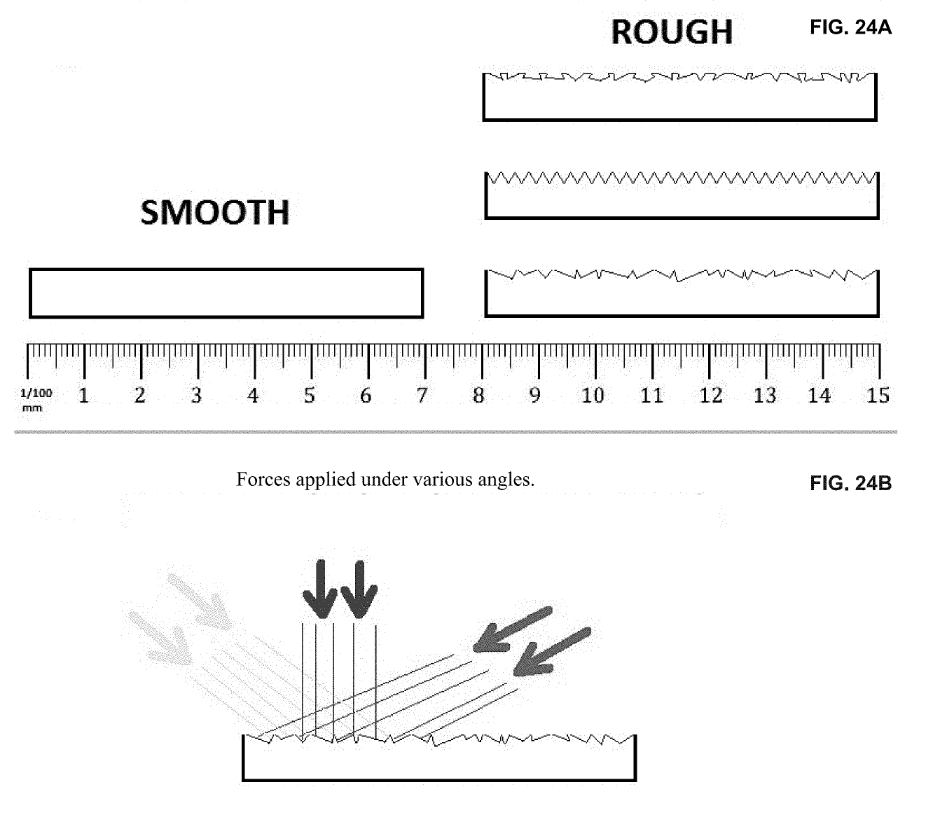

Having an improved bond with the surface of the analog can result in the analog providing structural support and rigidity to the die. Roughening the surface of analog, or adding rough material or objects to the surface of the analog, can enable the analog to create a mechanical bond between the casting material and the analog. Rough surfaces promote adhesion. In addition to such mechanical bonding improvements, roughening the surface would create angled surfaces or surface regions on the outer surface of the analog which can add strength against forces applied at various angles relative to the analog, which can allow the surface of the casting material and the surface of the analog to mechanically lock together. FIG. 24A shows examples of smooth and rough surfaces, any of which rough surfaces any embodiments of the analogs disclosed herein can have. FIG. 24B shows a depiction of forces being applied at various angles relative to a roughened surface. Creating a roughened surface finish on the surface of the analog can result in peaks and valleys or voids on the surface of the analog. Casting material, or small particles thereof, can advance into and fill the tiny valleys and voids on the surface of the analog, and can flow around microscopic peaks to create mechanical bonds or locks between the casting material and the surface of the analog. In some embodiments, this will increase the bonding and/or locking properties of the casting material and the analog as compared to dental models created using analogs with glossy or smooth surfaces, increasing the overall strength of the die and reducing the likelihood of fracture of the die during fabrication and handling procedures. Cohesion of gypsum to an analog with a roughened surface is much greater than with an analog having a smoother surface. Additionally, roughening the surface will increase the bonding surface area, to also improve the strength of the bonding interface between the casting material and the analog. This is because, with the same length of both, smooth and roughened analogs the distance of the rough surface measured by going deep in to the valleys and up to the peaks is greater comparing with straight line over the smooth surface of the same analog on the smooth finish.

As mentioned, for the research and testing purposes, the forces applied to the test specimen having the analog(s) with the roughened surface finish and the specimen having the conventional analog(s) replicated and were the same as or similar to forces that are typically applied to dies during dental restoration fabrication processes. In some cases, forces were applied to the test specimen until the point of fracture or failure of the test specimen, these forces being applied in a manner that is similar to the way forces are applied to dies during dental restoration fabrication processes. The result is that it required significantly more force (in some cases, approximately 15%-approximately 19% more force) to fracture dies made using the embodiments of the improved analogs of the present disclosure having greater surface roughness as compared to the force required to fracture dies using conventional analogs. Increasing the surface area will increase the strength of the bond between the casting material and the surface of the analog.

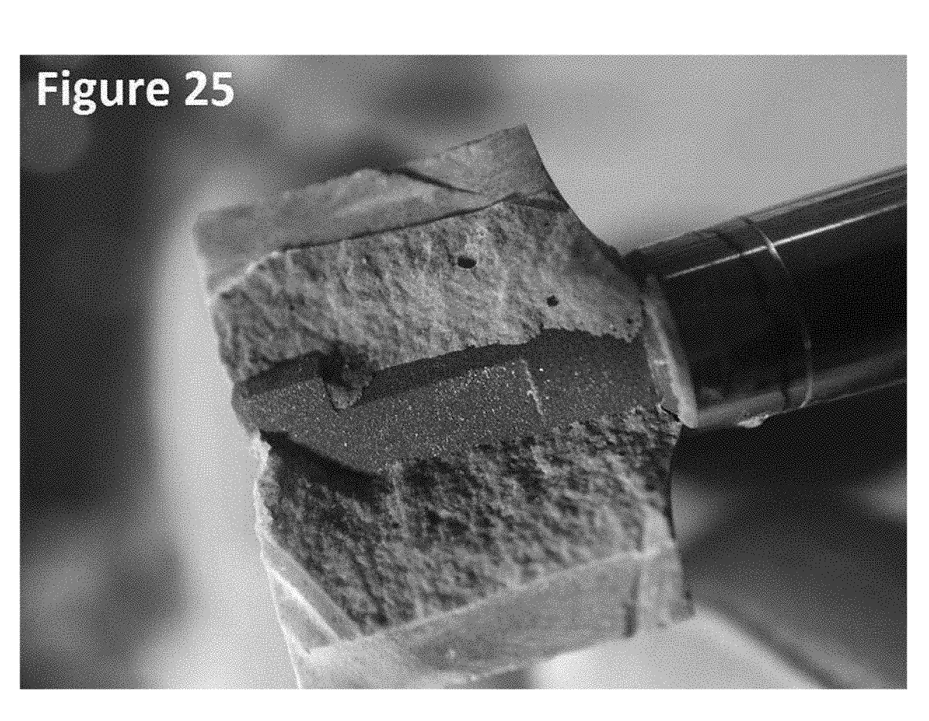

FIG. 25 shows fractured die that has fractured at the point of the dental model where an embodiment of an improved analog of the present disclosure was positioned. With reference to FIG. 25, the fracture surface of a broken die using an improved analog of the present disclosure has significantly different characteristics along the casting material—analog surface interface as compared to the fracture surface of a broken die using a conventional analog having a smoother surface finish (see FIG. 22).

Embodiments of the improved analog can be formed and/or manufactured using various techniques. In some embodiments, embodiments of the analog having a roughened exterior surface can be created using grit or abrasive blasting techniques or processes. The exterior surface of some embodiments of the improved analog to be roughened can be confined to the areas that will be exposed to the casting material during the fabrication of the dies. During grit/abrasive blasting processes, a stream of abrasive material under high pressure can be directed against the portion of the exterior surface of the analog desired to be roughened, which can create micro irregularities or hills and valleys on the surface of the analog. In any embodiments, a variety of different types of media can be used to create the surface roughness, depending on the desired level of surface roughness to be achieved.

Additionally, some embodiments of the improved analog can be treated with plasma and/or chemical etching of the surface of the analog to achieve a desired level of surface roughness and/or micro irregularities. In some embodiments, various types of acids can be used for this process. Electro etching techniques (using an anode and cathode method) can be used to achieve the desired level of surface roughness for optimal bonding. This can be done using any suitable electro etching systems or procedures.

Additionally, in some configurations, the desired surface finish can be achieved by spraying titanium, aluminum, or other alloy particles, shavings, or bits onto the exterior surface of the analog (which can be fused or otherwise coupled with the surface of the analog), creating the desired level of surface roughness. Other techniques may be used wherein particles and/or compounds are fused and/or soldered on to the surface of the analog to create the surface roughness and/or irregularities desired for improving the bonding characteristics with the casting material. In addition to fusing relatively bigger particles on the dental analog or after soldering particles on the surface, grit blasting with relatively smaller grit could be performed to create combination of two or more roughness levels. Additionally, micro level mechanical deformation/cutting of the exterior surface of the analog can increase the surface roughness and create peaks and valleys that can optimize the bonding with the casting material. As an example, without limitation, press-making tools can be used to create the desired level of surface treatment by deforming the surface of the analog to have features that engagement and/or better bonding with the casting material.

For research and testing purposes, a total of 84 implant models were fabricated. All 84 models were fabricated with the impressions provided from different doctors using various dental implant systems for fabrication of restorations of various teeth. All 84 implant models were fabricated using same type of gypsum materials with the consistent water and powder ratios, with exactly the same setting/drying time maintained and in relatively same room temperature of about 74 degrees Fahrenheit (plus or minus 4 degrees Fahrenheit). All 84 models were fabricated in a way not to exceed a 10-12 mm thickness of dentition cast. A total of 40 models were fabricated using conventional implant analogs (i.e, analogs having a smooth or glossy surface) and 44 models were fabricated using analogs with a roughened surface similar to some of the embodiments shown in the Figures of this application, such as in FIGS. 23 and 25. Approximately 100 micrometers abrasive sand was used to blast and roughen surface with air pressure setting of approximately 4.2 bars.

During restoration manufacturing procedures, a total number of 12 breakages of the models were recorded out of 40 models having a conventional implant analog, which equates to a 30% failure or breakage rate. The breakages were right in the area of implant analog. Of the 44 models having an analog having the surface roughness features and qualities of the embodiments disclosed herein, only 3 models fractured out of the 44 models, which equates to only a 7% failure or breakage rate. In this trial, using an analog with a roughened surface created by abrasive blasting of 100 micrometers abrasion particles under pressure of 4.2 bars increased the strength of these models by of the dental model by nearly 23%. This is an increase in the resistance to failure of approximately 440%.

Any of the embodiments disclosed herein of the assemblies, components, or parts can have any combination of the features, components, or other details of any of the other assemblies, components, or parts disclosed herein or known. Features, materials, characteristics, or groups described in conjunction with a particular aspect, embodiment, or example are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. Those skilled in the art will appreciate that in some embodiments, the actual steps taken in the processes illustrated and/or disclosed may differ from those shown in the figures. Depending on the embodiment, certain of the steps described above may be removed, others may be added. Accordingly, the scope of the present disclosure is intended to be defined only by reference to the appended claims. The accompanying claims and their equivalents are intended to cover such forms or modifications as would fall within the scope and spirit of the protection. Furthermore, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims or claims that will be added in the future.

Features, materials, characteristics, or groups described in conjunction with a particular aspect, embodiment, or example are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Many variations and modifications may be made to the embodiments described in this application, the elements of which are to be understood as being among other acceptable examples. All such modifications and variations are intended to be included herein within the scope of this disclosure and protected by the claims of this and all related applications. Moreover, any of the steps described herein can be performed simultaneously or in an order different from the steps as ordered herein. Moreover, the features and attributes of the specific embodiments disclosed herein may be combined in different ways to form additional embodiments, all of which fall within the scope of the present disclosure.

Conditional terms used herein, such as, among others, “can,” “could,” “might,” “may,” “e.g.,” and the like, unless specifically stated otherwise, or otherwise understood within the context as used, are generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

What is claimed is:

1. An improved implant analog for use in in the fabrication of dental restorations, comprising:
a main body; and
an outside surface of the main body;
wherein, to optimize the outside surface of the analog for bonding with a casting material, at least a portion of the outside surface of the main body of the improved implant analog has a roughness of from approximately 35 micrometers to approximately 550 micrometers.

2. The improved implant analog of claim 1, wherein at least a portion of the outside surface has a roughness of from approximately 50 micrometers to approximately 200 micrometers.

3. The improved implant analog of claim 1, wherein at least a portion of the outside surface has a roughness of from approximately 100 micrometers to approximately 150 micrometers.

4. The improved implant analog of claim 1, wherein at least a portion of the outside surface has a roughness of approximately 100 micrometers.

5. The improved implant analog of claim 1, wherein the portion of the outside surface of the main body of the improved implant analog that has a roughness of from approximately 35 micrometers to approximately 550 micrometers is the portion of the outside surface of the main body that will be embedded in the casting material.

6. The improved implant analog of claim 1, wherein the analog is used only for fabrication of dental restorations and is not configured for use in a patient's mouth.

7. An improved dental model for use in a dental laboratory, comprising;
a casting material; and
an improved analog having an exterior surface;
wherein at least a portion of the exterior surface of the improved analog has been roughened exterior surface adapted to provide better bonding with the casting material.

8. The improved dental model of claim 7, wherein at least a portion of the outside surface has a roughness of from approximately 35 micrometers to approximately 200 micrometers.

9. The improved dental model of claim 7, wherein at least a portion of the outside surface has a roughness of from approximately 50 micrometers to approximately 150 micrometers.

10. The improved dental model of claim 7, wherein the casting material comprises gypsum.

11. The improved dental model of claim 7, wherein the casting material comprises die stone.

12. The improved dental model of claim 7, wherein the dental model is from approximately 15% to approximately 20% stronger as compared to a conventional dental model that has the same casting material and a conventional analog that has a non-roughened exterior surface.

13. The improved dental model of claim 7, wherein the dental model is at least approximately 15% stronger as compared to a conventional dental model that has the same casting material and a conventional analog that has a non-roughened exterior surface.

14. A method of fabricating an improved die used in a dental laboratory for making dental restorations, comprising:
roughening at least a portion of an exterior surface of an analog;
positioning the analog in a desired position in an impression; and
advancing casting material around the portion of the analog that has the roughened surface and allowing such casting material to harden.

15. The method of claim 14, comprising roughening the exterior surface of the analog using grit blasting such as, but not limited to, sand blasting.

16. The method of claim 14, wherein the roughened portion of the exterior surface of the analog has a roughness of from approximately 35 micrometers to approximately 550 micrometers.

17. The method of claim 14, wherein roughened portion of the exterior surface of the analog has a roughness of from approximately 50 micrometers to approximately 200 micrometers.

18. The method of claim 14, wherein roughened portion of the exterior surface of the analog has a roughness of from approximately 100 micrometers to approximately 150 micrometers.

19. The method of claim 14, comprising roughening an entire exterior surface of the analog.

20. The method of claim 14, wherein the casting material comprises at least one of gypsum, resin, and epoxy.
